(19) United States
(12) Patent Application Publication
(10) Pub. No.: US 2013/0056684 A1
(43) Pub. Date: Mar. 7, 2013

(54) TREATMENT OF A CARBON DIOXIDE-RICH FRACTION OF A SYSTEM FOR PRODUCTION OF HYDROGEN AND CARBON MONOXIDE

(71) Applicant: Martin LANG, Munchen (DE)

(72) Inventor: Martin LANG, Munchen (DE)

(73) Assignee: LINDE AKTIENGESELLSCHAFT, Munchen (DE)

(21) Appl. No.: 13/603,501

(22) Filed: Sep. 5, 2012

(30) Foreign Application Priority Data
Sep. 6, 2011 (DE) 102011112655.8

(51) Int. Cl. B01D 53/38; C10L 3/00; C01B 3/02

(52) U.S. Cl. 252/373; 423/210; 48/197 FM

(57) ABSTRACT

The invention relates to a method for treatment of a carbon dioxide-rich gas fraction (16) containing oxidizable substances, which fraction occurs in the production of a synthesis gas (9), in which a hydrocarbon-containing feedstock (1) is conducted through the reformer tubes (R) arranged in the furnace chamber (F) of a burner-fired steam reformer (D) and in the process is converted into a crude synthesis gas (4) containing hydrogen, carbon monoxide, carbon dioxide and hydrocarbons. At least a part of the carbon dioxide-rich gas fraction (16) containing oxidizable substances is subjected to a thermal treatment in an oxygen-containing atmosphere, wherein oxidizable substances are burnt.

### SUMMARY OF THE INVENTION

The invention relates to a method for treatment of a carbon dioxide-rich gas mixture containing oxidizable substances, which gas mixture occurs in the production of a synthesis gas in which a hydrocarbon-containing feedstock is conducted through the reformer tubes that are arranged in the furnace chamber of a burner-fired steam reformer. In this method, the hydrocarbon-containing feedstock is converted into a crude synthesis gas containing hydrogen, carbon monoxide, carbon dioxide and hydrocarbons.

Hydrogen and carbon dioxide are frequently obtained industrially in systems (hereinafter termed H2/CO systems), the core of which is formed by a steam reformer in which hydrocarbons are converted into a crude synthesis gas. In addition to hydrogen and carbon monoxide, the crude synthesis gas also comprises relatively large amounts of water, carbon dioxide, and unconverted or only partially converted hydrocarbons. In further process steps in which, inter alia, carbon dioxide is separated off from the crude synthesis gas, a synthesis gas is formed that contains only hydrogen and carbon monoxide.

A steam reformer is a tubular furnace having an outer shell which, for heat insulation, is provided with a refractory internal cladding which encloses a furnace chamber. In the furnace chamber, reformer tubes are arranged. The inner surfaces of the reformer tubes are catalytically active, or the reformer tubes are entirely filled or at least partially filled in the region of the furnace chamber with a bed of a suitable catalyst material or a catalytically active structured packing. The hydrocarbons are conducted together with process steam through the reformer tubes and in the course of this process are converted in an endothermal reforming reactor into a crude synthesis gas.

The energy required for the reforming reaction is usually provided via burners that release their hot flue gases into the furnace chamber. Some of the heat present in the flue gases is transferred to the reformer tubes by radiation and convection, in such a manner that, although they are cooled, they still arrive hot from the furnace chamber into the following waste heat system. Via heat exchangers arranged here, further heat is withdrawn from the flue gases. This heat is used, e.g., for preheating the hydrocarbons or for generating process steam.

If, for example, an aMDEA scrubber is used for separating off carbon dioxide from the crude synthesis gas, the resultant carbon dioxide fraction contains methane and other oxidizable substances, such as hydrogen and carbon monoxide. In many H2/CO systems, the carbon dioxide fraction is recirculated and introduced into the reformer together with the hydrocarbons. If the H2/CO system, however, is intended to generate a high H₂/CO product ratio, frequently, only partial recirculation of the carbon dioxide fraction is possible. In some regions of the world, the non-utilizable part of the carbon dioxide fraction is, until now, simply released to the atmosphere. But, owing to stricter environmental requirements, in the future the release of such gas into the atmosphere will be permissible at fewer and fewer locations.

It is therefore an aspect of the present invention to provide a method, of the type described above, which overcomes the disadvantages of the prior art.

Upon further study of the specification and appended claims, other aspects and advantages of the invention will become apparent.

These aspects are achieved by a method wherein at least a part of the carbon dioxide-rich gas fraction containing oxidizable substances is subjected to a thermal treatment in an oxygen-containing atmosphere, wherein oxidizable substances are burnt.

Usually, the furnace chamber of a steam reformer is fired with an air excess, in such a manner that not only in the furnace chamber but also in the waste heat system, an atmosphere having free oxygen is present, the temperature of which is sufficiently high in order to ensure complete combustion of the oxidizable substances present in the carbon dioxide-rich gas fraction. A preferred embodiment of the method according to the invention therefore provides that a part of the carbon dioxide-rich gas fraction containing oxidizable substances that is intended for a thermal treatment is introduced in whole or in part into the furnace chamber and/or the waste heat system of the steam reformer.

A part of the carbon dioxide-rich gas fraction containing oxidizable substances that is intended for a thermal treatment can be introduced in various ways into the furnace chamber. For instance, it is possible, for example, to pass it via one or more burners by which the furnace chamber of the steam reformer is heated. For this purpose, the part of the gas fraction can be added to a fuel gas that is provided for the burners and/or to an oxidant intended for the burners, in such a manner that it enters into the furnace chamber via the channels that are provided at the top of a burner for fuel gas or oxidant.

In addition or alternatively, a part of the carbon dioxide-rich gas fraction containing oxidizable substances that is intended for a thermal treatment can be introduced into the furnace chamber of the steam reformer through a separate feed channel via a burner.

In addition, it is proposed to introduce a part of the carbon dioxide-rich gas fraction containing oxidizable substances that is intended for a thermal treatment directly into the furnace chamber of the steam reformer through a separate feed channel, independently of the burner or burners.

An expedient variant of the method according to the invention provides feeding a part of the carbon dioxide-rich gas fraction containing oxidizable substances that is intended for a thermal treatment to a flare and/or a catalytic or regenerative afterburning appliance and/or to an oven operated in parallel to the steam reformer, in order to burn oxidizable substances.

Another expedient variant of the method according to the invention provides carrying out the carbon dioxide separation in such a manner that at least two carbon dioxide fractions are produced. The first smaller carbon dioxide fraction contains the majority of the oxidizable substances and the second larger carbon dioxide fraction is substantially free from environmentally harmful constituents, and therefore is released to the atmosphere. The first carbon dioxide fraction can either be recirculated upstream of the steam reformer or subjected to a thermal treatment, as described above. If a gas scrubber is used for carbon dioxide separation, two carbon dioxide fractions can be obtained, for example by an intermediate expansion.

In a development of the method according to the invention, it is proposed to add at least a part of the carbon dioxide fraction to the synthesis gas at the entry into a pressure-swing absorption system (PSA) in which a hydrogen product is obtained from a hydrogen-rich gas fraction separated off from synthesis gas. By this means the oxidizable substances from the carbon dioxide fraction are combined with the purge gas of the PSA, which purge gas is in any case underfired at the reformer, i.e., it is fed into the reformer, where the oxidizable substances are burnt. An advantage of this procedure is a higher hydrogen yield in the PSA. However, it is necessary to dimension the PSA to be correspondingly larger.

### BRIEF DESCRIPTION OF THE DRAWINGS

Various other features and attendant advantages of the present invention will be more fully appreciated as the same becomes better understood when considered in conjunction with the accompanying drawings wherein:

FIG. 1 illustrates an exemplary embodiment according to the invention.

FIG. 1 shows an H2/CO system having a steam reformer in which a carbon monoxide product is obtained in a cryogenic gas separation unit and a hydrogen product is obtained using a pressure-swing adsorber.

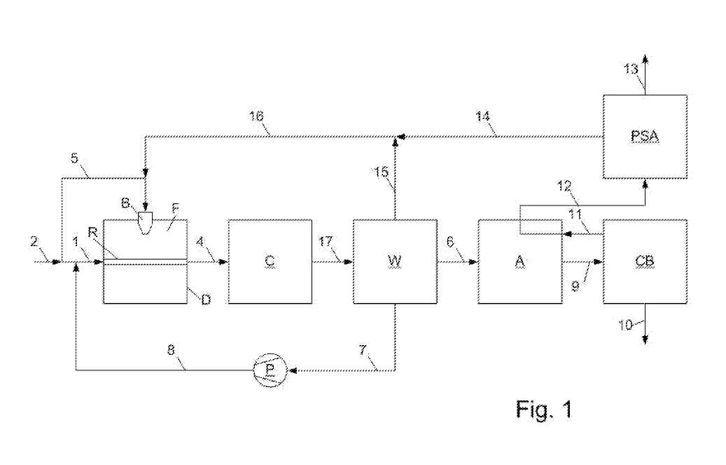

Via line 1, a first part of the hydrocarbon-rich material stream 2 which, for example, is natural gas, is introduced into the reformer tubes R of the steam reformer D, where it is reacted with catalytic support together with steam to form a crude synthesis gas 4 containing hydrogen, carbon monoxide, carbon dioxide and hydrocarbons. The second part 5 of the hydrocarbon-rich material stream 2 is used as fuel for heating the reformer tubes R and for this purpose is introduced via the burners B into the furnace chamber F of the steam reformer D.

Water condenses out of the crude synthesis gas 4 in the cooler C, before said water arrives via line 17 into the carbon dioxide separation W, which is, for example, an aMDEA scrubber. Here, carbon dioxide is separated off, wherein a gas mixture 6 substantially comprising carbon monoxide and hydrogen, and also a carbon dioxide-rich gas stream containing oxidizable substances such as hydrogen, carbon monoxide and hydrocarbons, are formed, which, on account of the composition thereof, cannot be released into the atmosphere. A subquantity 7 of the carbon dioxide-rich gas stream containing oxidizable substances, the size of which is restricted by the minimum possible H₂/CO ratio in the crude synthesis gas which is decreased by the recirculated amount of carbon dioxide, is therefore recirculated via the compressor P and the line 8 to a point upstream of the steam reformer D and added to the material stream 1.

The gas mixture 6 substantially comprising carbon monoxide and hydrogen, for separation of carbon dioxide residues and water is passed on into the adsorber station A, from which via line 9 a synthesis gas comprising carbon monoxide and hydrogen is taken off and introduced into the cryogenic gas separation unit CB for separation into a carbon monoxide product 10 and a hydrogen fraction 11 containing carbon monoxide. The hydrogen fraction 11 is used as regenerating gas in the adsorber station A, and then introduced as gas stream 12 into the pressure-swing adsorber PSA. By separating off impurities, a high-purity hydrogen product 13 is generated in the pressure-swing adsorber PSA from the gas stream 12, wherein, at the same time, a purge gas stream 14 is produced.

The remainder 15 of the gas stream from the carbon dioxide separation W that is carbon dioxide-rich and contains oxidizable substances and cannot be recirculated upstream of the steam reformer D is combined with the purge gas stream 14 to form a carbon dioxide-rich gas fraction 16 containing oxidizable substances and then, together with the fuel gas 5, is introduced into the furnace chamber F of the steam reformer D. Owing to the oxygen present in the furnace chamber atmosphere and the high temperatures prevailing in the furnace chamber F, the oxidizable substances are burnt to substances whose release into the atmosphere is not a problem.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German application No. 10 2011 112 655.8, filed Sep. 6, 2011, are incorporated by reference herein.

1. A method for treatment of a carbon dioxide-rich gas fraction containing oxidizable substances, which fraction occurs in the production of a synthesis gas, in which a hydrocarbon-containing feedstock is conducted through reformer tubes arranged in a furnace chamber of a burner-fired steam reformer wherein the hydrocarbon-containing feedstock is converted into a crude synthesis gas containing hydrogen, carbon monoxide, carbon dioxide and hydrocarbons, said method comprising:
subjecting at least a part of said carbon dioxide-rich gas fraction containing oxidizable substances to a thermal treatment in an oxygen-containing atmosphere, wherein oxidizable substances are burnt.

2. The method according to claim 1, wherein a part of the carbon dioxide-rich gas fraction containing oxidizable substances that is intended for a thermal treatment is introduced into the furnace chamber and/or a waste heat system of the steam reformer.

3. The method according to claim 2, wherein a part of the carbon dioxide-rich gas fraction containing oxidizable substances that is intended for a thermal treatment is added to a fuel gas for a burner arranged in the furnace chamber of the steam reformer.

4. The method according to claim 2, wherein a part of the carbon dioxide-rich gas fraction containing oxidizable substances that is intended for a thermal treatment is added to an oxidant for a burner arranged in the furnace chamber of the steam reformer.

5. The method according to claim 2, wherein the carbon dioxide-rich gas fraction containing oxidizable substances is introduced into the furnace chamber of the steam reformer through a separate feed channel via a burner arranged in the furnace chamber of the steam reformer.

6. The method according to claim 2, wherein a part of the carbon dioxide-rich gas fraction containing oxidizable substances that is intended for a thermal treatment is introduced directly into the furnace chamber of the steam reformer through a separate feed channel.

7. The method according to claim 1, wherein a part of the carbon dioxide-rich gas fraction containing oxidizable substances that is intended for a thermal treatment is fed to a flare and/or a catalytic or regenerative afterburning appliance and/or an oven operated in parallel to the steam reformer.

8. A method for the production of a synthesis gas and the treatment of a carbon dioxide-rich gas fraction containing oxidizable substances obtained therefrom, said method comprising:
conducting a hydrocarbon-containing feedstock through one or more reformer tubes arranged in a furnace chamber of a burner-fired steam reformer wherein the hydrocarbon-containing feedstock is converted into a crude synthesis gas containing hydrogen, carbon monoxide, carbon dioxide and hydrocarbons;
subjecting the crude synthesis gas containing hydrogen, carbon monoxide, carbon dioxide and hydrocarbons to a carbon dioxide removal stage to produce a synthesis gas containing carbon monoxide and hydrogen, and a carbon dioxide-rich gas fraction containing oxidizable substances; and
subjecting at least a part of said carbon dioxide-rich gas fraction containing oxidizable substances to a thermal treatment in an oxygen-containing atmosphere, wherein oxidizable substances are burnt.

9. The method according to claim 8, wherein prior to said carbon dioxide removal stage, said crude synthesis gas is subjected to a cooler stage to condense water.

10. The method according to claim 8, wherein after to said carbon dioxide removal stage, said synthesis gas is subjected to ah adsorber stage and then a cryogenic gas separation stage to produce a carbon monoxide product stream and a hydrogen fraction.

11. The method according to claim 10, wherein said hydrogen fraction is used as a purge stream in said adsorber stage and is then subjected to a pressure swing adsorption stage to produce a hydrogen product stream.

12. The method according to claim 11, wherein a purge stream is removed from said pressure swing adsorption stage and combined with at least a part of said carbon dioxide-rich gas fraction containing oxidizable substances, and the resultant mixture is burnt in the furnace chamber of said burner-fired steam reformer.

13. The method according to claim 8, wherein a part of the carbon dioxide-rich gas fraction containing oxidizable substances that is intended for a thermal treatment is introduced into the furnace chamber and/or a waste heat system of the steam reformer.

14. The method according to claim 13, wherein a part of the carbon dioxide-rich gas fraction containing oxidizable substances that is intended for a thermal treatment is added to a fuel gas for a burner arranged in the furnace chamber of the steam reformer.

15. The method according to claim 13, wherein a part of the carbon dioxide-rich gas fraction containing oxidizable substances that is intended for a thermal treatment is added to an oxidant for a burner arranged in the furnace chamber of the steam reformer.

16. The method according to claim 13, wherein the carbon dioxide-rich gas fraction containing oxidizable substances is introduced into the furnace chamber of the steam reformer through a separate feed channel via a burner arranged in the furnace chamber of the steam reformer.

17. The method according to claim 13, wherein a part of the carbon dioxide-rich gas fraction containing oxidizable substances that is intended for a thermal treatment is introduced directly into the furnace chamber of the steam reformer through a separate feed channel.

18. The method according to claim 8, wherein a part of the carbon dioxide-rich gas fraction containing oxidizable substances that is intended for a thermal treatment is fed to a flare and/or a catalytic or regenerative afterburning appliance and/or an oven operated in parallel to the steam reformer.
